(19) United States
(12) Patent Application Publication
(10) Pub. No.: US 2010/0222532 A1
(43) Pub. Date: Sep. 2, 2010

(54) Polystyrene Having High Melt Flow and High Vicat

(75) Inventors: Joe Shuler, League City, TX (US); Jose M. Sosa, Deer Park, TX (US); Juan Aguirre, League City, TX (US); John Gaustad, Friendswood, TX (US)

Correspondence Address: David J. Alexander;Fina Technology, Inc., P.O. Box 674412, Houston, TX, 77267-4412, US

(73) Assignee: FINA TECHNOLOGY, INC., Houston, TX (US)

(21) Appl. No.: 12/395,578

(22) Filed: Feb. 27, 2009

(51) Int. Cl. C08F 230/04

(52) U.S. Cl. 526/240

(57) ABSTRACT

A monovinylidene aromatic polymer with a melt flow index of at least 7 g/10 min and a Vicat softening temperature of at least 200° F. may be useful for injection molding with reduced cycle time. The monovinylidene aromatic polymer may be general purpose polystyrene or high impact polystyrene. It may include reduced amounts of mineral oil and increased amounts of an additive such as zinc dimethacrylate to optimize its processability and mechanical characteristics.

### CROSS-REFERENCE TO RELATED APPLICATIONS

Not Applicable.

### FIELD

The present invention generally relates to the production of monovinylidene, aromatic polymers, such as general purpose polystyrene (GPPS).

### BACKGROUND

General purpose polystyrene (GPPS), also referred to as crystal grade polystyrene, is made from styrene, a vinyl aromatic monomer that can be produced from petroleum. GPPS is useful in a variety of applications. For example, it can serve as a hard casing for appliances, can serve as a coating for sports equipment, or can be expanded to create foam, and it has many other uses as well. One common application of GPPS is injection molding, for the production of molded plastic products such as cups and utensils.

Injection molding generally involves feeding plastic polymer, such as in pellet form, through a hopper into a horizontal barrel containing a revolving screw. The plastic is forced through the barrel by the screw, and the shearing force of the screw along with applied heat is able to melt the plastic. Upon reaching the front of the screw, shots of molten plastic may enter the mold through one or more gates. The mold can be made of two halves that, when in contact with each other, form the inverse of the desired shape of the molded product. The molding cycle generally consists of the mold closing, filling with molten plastic, holding and cooling, mold opening, and ejection of the plastic product.

Certain properties affect the suitability of a plastic for injection molding applications. Properties that reduce the cycle time of injection molding are generally desirable. A reduced cycle time can allow for greater efficiency in the production of molded plastics by increasing the number of plastics products ejected from the mold in a given period of time.

One property of plastics that can greatly influence cycle time is melt flow rate, also known as melt flow index (MFI). By increasing the MFI molten plastic can flow more quickly through the one or more mold gates that introduce the molten plastic into the mold and can more quickly fill the mold. Thus, the mold cycle time can be shortened. Melt flow can be increased in a variety of ways. One method is to lower the molecular weight of the plastic. Molecular weight can be influenced by factors such as polymerization time, initiator, and the use of a chain transfer agent. A lower molecular weight generally results in a lower viscosity, which eases the flow of the molten plastic through the barrel and into the mold. MFI can also be adjusted by using different additives, such as plasticizers and flow modifiers. Cycle time can be influenced by the thermal properties of the material, generally defined by their Vicat softening temperature. It is desirable to reduce cycle time and increase mass throughput, while maintaining similar mechanical properties, for example, tensile or flexural modulus.

Increasing MFI can have the unwanted effect of lowering physical properties of the plastic. For instance, an increase in MFI is generally accompanied by a decrease in melt strength and elongation. It is often a goal in the art to balance processability with physical properties, and there have been many proposed methods of achieving such a balance, such as by lowering gel content by minimizing cross-linking, lowering the molecular weight distribution or polydispersity, and using additives like furfuryl acetate and esters of acrylates.

It is always desirable in the art to find new ways of increasing processability without sacrificing physical properties. It is thus desirable to create a novel monovinylidene aromatic polymer exhibiting a high melt flow without a significant loss of mechanical properties.

### SUMMARY

Embodiments of the present invention generally include a monovinylidene aromatic copolymer, the polymerization product of a first monomer and a second metallic comonomer, the copolymer having with a melt flow index of at least 7 g/10 min and a Vicat softening temperature of at least 200° F. In embodiments the melt flow index can range from 7 to 30 g/10 min and the Vicat softening temperature can range from 200° F. to 300° F. Increased melt flow and high Vicat may be useful for injection molding with reduced cycle time. With increased MFI, molten plastic may more quickly enter the mold. With increased Vicat, the molded article may solidify more quickly upon cooling. Together, high MFI and Vicat may reduce injection molding cycle time and increase processing efficiency. Further, increasing MFI while retaining high thermal properties may prevent significant loss of mechanical properties such as strength.

The monovinylidene aromatic polymer may be general purpose polystyrene wherein the styrenic monomer is styrene or a substituted styrene compound. The monovinylidene aromatic polymer may also be high impact polystyrene, wherein a 1,3-conjugated diene is dispersed in a styrenic matrix.

The monovinylidene aromatic polymer may include reduced amounts of mineral oil and increased amounts of zinc dimethacrylate (ZnDMA) to optimize its processability and mechanical characteristics. It may contain less than 4%, optionally less than 2%, optionally 0% by weight of mineral oil. It may contain at least 100 ppm, optionally from 500 to 2000 ppm of ZnDMA. It may contain other additives, such as zinc stearate and n-dodecyl mercaptan (NDM). It may contain from 100 to 4000 ppm, optionally from 1000 to 2000 ppm, optionally from 1000 to 1500 ppm of zinc stearate. It may contain at least 100 ppm, optionally from 100 to 500 ppm of NDM.

The monovinylidene aromatic polymer may have a moderate to high molecular weight and mechanical properties. Number average molecular weight (Mn) may be from 50 kg/mol to 100 kg/mol, optionally 60 kg/mol to 90 kg/mol, optionally 75 kg/mol to 85 kg/mol. Weight average molecular weight (Mw) may be from 130 kg/mol to 400 kg/mol, optionally 150 kg/mol to 300 kg/mol. Polydispersity, which is measured as Mw over Mn, may range from 1.5 to 3.5. Tensile strength at yield may be from 4,000 to 7,000 PSI. Flexural strength may be 6,000 to 15,000 PSI. Flexural modulus may be 400,000 to 500,000 PSI. Elongation at yield may be from 1 to 2%.

A further embodiment is a method of producing a copolymer having reduced cycle time that includes providing a first monomer and a second metallic comonomer and polymerizing the first monomer and second metallic comonomer to make a monovinylidene aromatic copolymer having a melt flow index of at least 7 g/10 min and a Vicat softening temperature of at least 200° F. The first monomer may be a styrene monomer and the metallic comonomer may be selected from the group of zinc diacrylate, zinc dimethacrylate, zinc di-vinylacetate, zinc di-ethylfumarate: copper diacrylate, copper dimethacrylate, copper di-vinylacetate, copper di-ethylfumarate; aluminum (III) isopropoxide, aluminum triacrylate, aluminum trimethacrylate, aluminum tri-vinylacetate, aluminum tri-ethylfumarate; zirconium tetraacrylate, zirconium tetramethacrylate, zirconium tetra-vinylacetate, zirconium tetra-ethylfumarate, zirconium (IV) butoxide; and mixtures thereof. The monovinylidene aromatic copolymer may have a weight average molecular weight Mw greater than 150 kg/mol.

### BRIEF DESCRIPTION OF DRAWINGS

FIG. 1 shows mass throughput in g/hr versus screw speed in rpm for extrusion tests of eight GPPS samples.

FIG. 2 shows the slope of mass throughput over screw speed in g/hr/RPM as well as ZnDMA concentration in ppm for extrusion tests of eight GPPS samples.

FIG. 3 shows the cycle time in seconds and Vicat softening temperatures in degrees Fahrenheit for injection molding tests of eight GPPS samples.

### DETAILED DESCRIPTION

Improved thermal properties can contribute to reduced cycle times when producing products from plastics. Thermal properties of plastics are generally defined by their Vicat softening temperature. Vicat softening temperature, alternatively known as Vicat softening point, is determined using the procedure described in ASTM Publication D 1525-91. This procedure determines the temperature at which a flat-ended needle of 1 mm² circular cross-section will penetrate a plastic of a certain volume to a depth of 1 mm under a load of 1 kg using a selected uniform rate of temperature rise. A plastic possessing a high Vicat softening temperature can be more resistant to heat. A high Vicat softening point can reduce the cycle time in injection molding. A higher Vicat softening temperature allows for the molten plastic to solidify more quickly upon cooling of the molded form, thus allowing for quick ejection of the molded product and rapid initiation of the next mold cycle.

The present invention relates to a monovinylidene aromatic polymer with a high MFI and a high Vicat softening temperature. Melt flow index is defined in accordance with ASTM D1238 as the amount, in grams, of plastic which can be forced through a capillary die in ten minutes when subjected to a force of 2160 grams at 200° C. Herein, a MFI will be considered “high” if it is greater than 7 g/10 min, such as in the range of from 7 g/10 min to 30 g/10 min, optionally, from 10 g/10 min to 20 g/10 min. Herein, a Vicat softening temperature will be considered “high” if it is greater than 200° F., such as in the range of from 200° F. to 300° F., optionally from 215° F. to 230° F. High Vicat temperatures are generally associated with high mechanical properties. It is desirable to have a plastic with both a high MFI and a high Vicat temperature, while retaining physical properties such as strength.

One aspect of the present invention is the limited use of plasticizer such as mineral oil. While mineral oil typically has the effect of increasing melt flow, it can also decrease the Vicat softening point. Thus, mineral oil can be used in the amount of less than 4% by weight, optionally less than 2%, or optionally 0%.

Another aspect of the present invention is the use of metal comonomers, such as metal methacrylates as ionic comonomers in the polymerization to create a branched ionomer. Metal methacrylates, such as zinc dimethacrylate (ZnDMA), may be copolymerized with styrenic monomers, to create reversible crosslinks, thus increasing some of polymer's mechanical properties. The method for the production of branched ionomers is disclosed in U.S. Pat. Nos. 7,309,749 and 7,179,873 to Reimers et al., which are incorporated by reference in their entirety. Metal comonomers, such as zinc dimethacrylate, may be added to the reactor vessel in amounts of from 100 to 2000 ppm, optionally 500 to 1250 ppm.

An amount of zinc stearate or another metal stearate may be added as a flow modifier. Metallic stearates can act as lubricants in the injection molding process, and can aid in the release of the product from the mold. Metallic stearates may be added in the amount of from 100 to 4000 ppm, optionally from 1000 to 2000 ppm, optionally around 1250 ppm.

Other additives known in the art to be useful in the production of styrenic polymers may be used. For instance, 100 to 500 ppm of n-dodecyl mercaptan (NDM), or another mercaptan or similar compound, may be used as a chain-transfer agent, to lower the molecular weight.

Any conventional polymerization initiators having one hour half-lives between 80 to 150° C. may be used, and any combination of temperature profiles known to be useful in the polymerization of styrenic polymers may be employed. The polymerization process may be operated under batch or continuous process conditions. In an embodiment, the polymerization reaction may be carried out using a continuous production process in a polymerization apparatus comprising a single reactor or a plurality of reactors. In an embodiment of the invention, the polymeric composition can be prepared for an upflow reactor. Reactors and conditions for the production of a polymeric composition are disclosed in U.S. Pat. No. 4,777,210, to Sosa et al., which is incorporated by reference in its entirety.

Styrenic monomers that may be used include monovinylaromatic compounds such as styrene as well as alkylated styrenes wherein the alkylated styrenes are alkylated in the nucleus or side-chain. Alphamethyl styrene, t-butylstyrene, p-methylstyrene, methacrylic acid, and vinyl toluene are monomers that may be useful in forming a polymer of the invention. These monomers are disclosed in U.S. Pat. No. 7,179,873 to Reimers et al., which is incorporated by reference in its entirety. The styrenic polymer may be a homopolymer or may optionally comprise one or more comonomers. As used herein the term styrene includes a variety of substituted styrenes (e.g. alpha-methyl styrene), ring substituted styrenes such as p-methylstyrene, distributed styrenes such as p-t-butyl styrene as well as unsubstituted styrenes, and including combinations thereof.

A non-limiting listing of possible metal comonomers can be selected from the group of: zinc diacrylate, zinc dimethacrylate, zinc di-vinylacetate, zinc di-ethylfumarate: copper diacrylate, copper dimethacrylate, copper di-vinylacetate, copper di-ethylfumarate; aluminum (III) isopropoxide, aluminum triacrylate, aluminum trimethacrylate, aluminum tri-vinylacetate, aluminum tri-ethylfumarate; zirconium tetraacrylate, zirconium tetramethacrylate, zirconium tetra-vinylacetate, zirconium tetra-ethylfumarate, zirconium (IV) butoxide; and mixtures thereof.

The monovinylidene aromatic polymer may be general purpose polystyrene or a rubber modified polymeric composition, such as high impact polystyrene, where an amount of rubber in dispersed in a styrenic matrix. Polybutadiene or a polymer of a conjugated 1,3-diene may be used in an amount of from 0.1 wt % to 50 wt % or more, or from 1% to 30% by weight of the rubber-styrene solution.

Several sample batches of general purpose polystyrene were prepared to demonstrate the present invention. These examples are given as illustrative embodiments of the present invention, and are not intended to limit the scope of the invention.

Seven samples were prepared according to the present invention, and compared with a control sample of Total Petrochemical 500W crystal grade polystyrene. The samples were prepared with styrene monomer, 0 to 2.6% by weight mineral oil, and 0 to 1250 ppm ZnDMA. Materials were prepared in a continuous process with Arkema Lupersol L-233 as initiator. The reactor train temperature profile was 265° F. -345° F. and devolatilization temperatures ranging between 440°-450° F. The samples were tested for melt flow index and Vicat softening temperature according to the ASTM standard procedures. Table 1 shows several properties of the eight polymers, including physical properties, processability, and additives present.

TABLE 1
Characterization of Sample Polymers

| | Sample | | | | | | | |
|---|---|---|---|---|---|---|---|---|
| | A | | | | | | | |
| | 500W | | | | | | | |
| | Control | B | C | D | E | F | G | H |
| MFI, g/10 min | 12.8 | 15.9 | 13.4 | 17.7 | 23.8 | 15.4 | 25.8 | 23.4 |
| ZnDMA, | 0 | 0 | 800 | 800 | 800 | 1250 | 1250 | 1250 |
| ppm | | | | | | | | |
| % MO | 2.6 | 1.87 | 0 | 0 | 0 | 0.92 | 0 | 0.87 |
| Vicat, ° F. | 201 | 201 | 217 | 218 | 217 | 215 | 212 | 216 |
| Ten. Str., | 5900 | 6010 | 5560 | 4570 | 5660 | 5810 | 5560 | 4900 |
| PSI | | | | | | | | |
| Elong., % | 1.6 | 1.53 | 1.41 | 1.07 | 1.4 | 1.4 | 1.3 | 1.2 |
| at yield | | | | | | | | |
| Flexural | 450000 | 456000 | 462000 | 460000 | 461000 | 462000 | 461000 | 462000 |
| Modulus, | | | | | | | | |
| PSI | | | | | | | | |
| Flexural | 11300 | 10400 | 9200 | 8500 | 7100 | 9300 | 8200 | 7300 |
| Strength, | | | | | | | | |
| PSI | | | | | | | | |
| Mass | 191.2 | 208.5 | 210.3 | 217.1 | 217.1 | 223.5 | 226.5 | 230.6 |
| Throughput | | | | | | | | |
| slope, g/hr | | | | | | | | |
| Cycle | 25.4 | 27.3 | 21.3 | 22.3 | 20.3 | 21.3 | 26.3 | 25.3 |
| Time, s | | | | | | | | |
| M(n) | 76000 | 84000 | 65000 | 63000 | 62000 | 66000 | 64000 | 60000 |
| g/mol | | | | | | | | |
| M(w) | 235000 | 204000 | 157000 | 152000 | 134000 | 163000 | 146000 | 137000 |
| g/mol | | | | | | | | |
| M(z) | 428000 | 359000 | 279000 | 264000 | 217000 | 286000 | 245000 | 233000 |
| g/mol | | | | | | | | |
| M(w)/M(n) | 3.1 | 2.4 | 2.4 | 2.4 | 2.2 | 2.5 | 2.3 | 2.3 |
| PDI | | | | | | | | |
| M(z)/M(w) | 1.8 | 1.8 | 1.8 | 1.7 | 1.6 | 1.8 | 1.7 | 1.7 |

One row of data from Table 1 is labeled “Mass Throughput slope, g/hr” Mass throughput indicates the processability of a polymer in extrusion, a process whereby plastic is forced through a die of a certain shape to create an object with a fixed cross-sectional profile. The characteristics desirable for extrusion applications are similar to those desirable for injection molding. Increased MFI, for instance, can increase production efficiency in both processes. For the eight samples characterized in Table 1, mass throughput tests were conducted using a Davis Standard Mini Coex line. The mini coex was used in cast film mode using a ACCCB selector plug. The mass throughput was determined after 5 minutes of extrusion with a triple replicate for each sample. Throughput was recorded at 25, 50, 75, and 100 RPMs and demonstrates the processing efficiency of each grade.

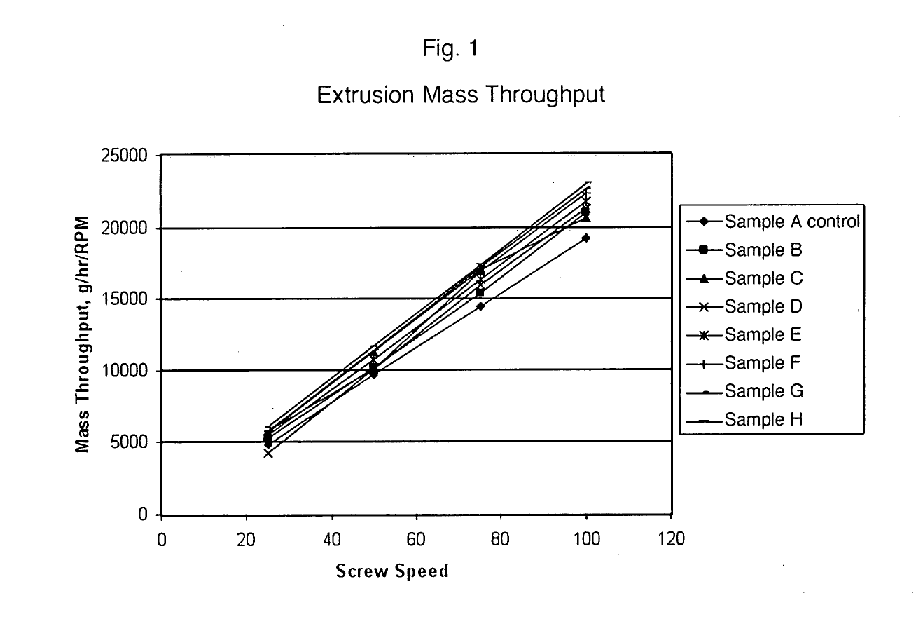

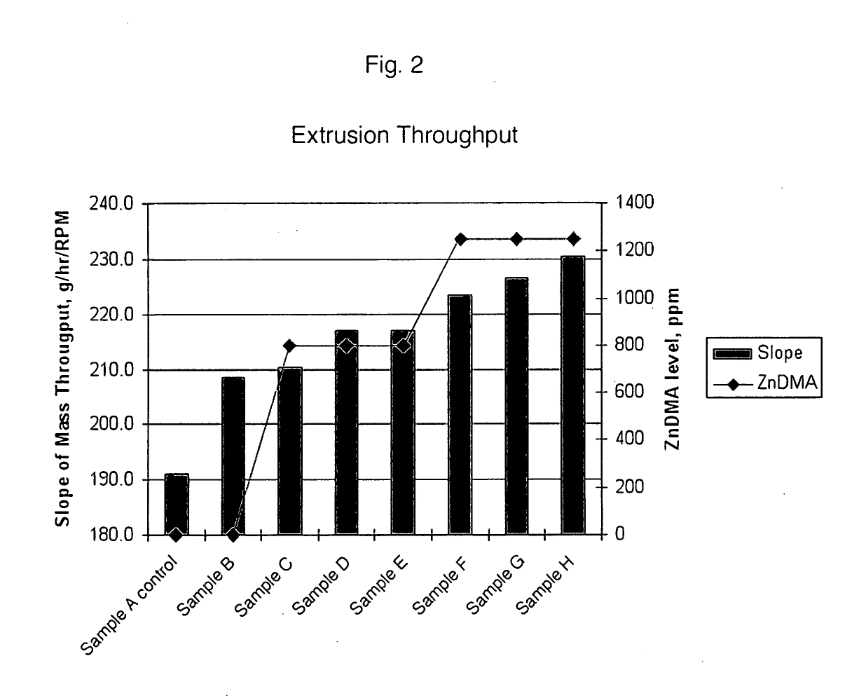

FIG. 1 shows mass throughput versus screw speed for the eight polystyrene samples. The slope of mass throughput versus screw speed can be employed to characterize the throughput due to the linear response to screw speed that is apparent. FIG. 2 shows the slope of mass throughput over screw speed as well as concentration of ZnDMA. A higher concentration of ZnDMA coincides with a higher slope of mass throughput. Higher concentrations of ZnDMA may therefore increase processability.

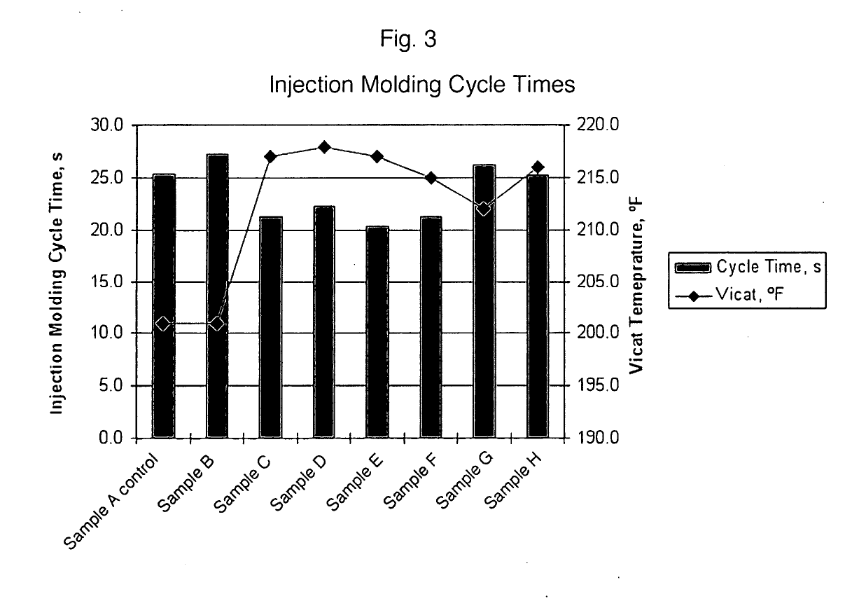

The eight polystyrene samples were also tested for cycle time in injection molding. Injection molding cycle time was determined on a Van Dorn injection molder using a 125 ml plaque. The row in Table 1 labeled “cycle time, s” shows the results of the test. FIG. 3 is a chart of cycle time and Vicat softening temperature for the eight samples. In four of the samples, samples C, D, E and F, cycle times decreased and the Vicat increased by 15° F. Differences in cycle time primarily represent differences in cooling time. This observation corresponds to the suggestion that increased thermal properties may reduce cycle time by allowing the molten plastic to solidify more quickly upon cooling of the molded form. Packing and hold times are consistent for all samples at 1.25±0.5 s and 4 s, respectively.

The samples were also tested for mechanical properties, including tensile strength at yield (PSI), flexural strength (PSI), flexural modulus (PSI), and elongation at yield (%). These characteristics are all shown in Table 1. Sample B and the control Sample A show the highest mechanical characteristics, which may be due to their higher molecular weights. Table 1 shows number average molecular weight (Mn), weight average molecular weight (Mw), and z average molecular weight for all the samples (Mz).

Number average molecular weight (Mn), according to the present invention, may be from 50 kg/mol to 100 kg/mol, optionally 60 kg/mol to 90 kg/mol, optionally 75 kg/mol to 85 kg/mol. Weight average molecular weight (Mw) may be from 130 kg/mol to 400 kg/mol, optionally 150 kg/mol to 300 kg/mol. Polydispersity, which is measured as Mw over Mn, may range from 1.5 to 3.5.

Tensile strength at yield may be from 4,000 to 7,000 PSI. Flexural strength may be from 6,000 to 15,000 PSI. Flexural modulus may be from 400,000 to 500,000 PSI. Elongation at yield may be from 1 to 2%.

As shown in Table 1, each of the samples has a flexural modulus ranging from 456,000 to 462,000 PSI, all of which are greater than the control sample A. A comparison of sample C with control sample A indicates that, while maintaining flexural modulus and MFI, the cycle time can be reduced by taking out the mineral oil and an increase in mass throughput can be realized. A comparison of sample E with control sample A indicates that, while maintaining flexural modulus, the MFI can be further increased by about 86%, the cycle time can be further reduced and mass throughput further increased with a reduction of Mw. A comparison of samples C and F with control sample A indicates that, while maintaining similar MFI values, the amounts of mineral oil and ZnDMA can be varied to optimize the formulation and achieve greater mass throughput. If however the MFI is increased further while not maintaining Mw above 150,000, as in samples G and H, the cycle time increases.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A monovinylidene aromatic copolymer comprising the polymerization product of a first monomer and a second metallic comonomer, the copolymer having a melt flow index of at least 7 g/10 min and a Vicat softening temperature of at least 200° F.

2. The copolymer of claim 1, wherein the copolymer has a melt flow index of from 10 to 30 g/min.

3. The copolymer of claim 1, wherein the copolymer has a Vicat softening temperature of from 210° to 250° F.

4. The copolymer of claim 1, wherein the copolymer is general purpose polystyrene, made from styrene monomer.

5. The copolymer of claim 4, wherein the styrene monomer is styrene or a substituted styrene compound.

6. The copolymer of claim 1, wherein the copolymer is a high impact polystyrene that includes a conjugated 1,3-diene.

7. The copolymer of claim 1, wherein the metallic comonomer is selected from the group of: zinc diacrylate, zinc dimethacrylate, zinc di-vinylacetate, zinc di-ethylfumarate: copper diacrylate, copper dimethacrylate, copper di-vinylacetate, copper di-ethylfumarate; aluminum (III) isopropoxide, aluminum triacrylate, aluminum trimethacrylate, aluminum tri-vinylacetate, aluminum tri-ethylfumarate; zirconium tetraacrylate, zirconium tetramethacrylate, zirconium tetra-vinylacetate, zirconium tetra-ethylfumarate, zirconium (IV) butoxide; and mixtures thereof.

8. The copolymer of claim 7, wherein the copolymer comprises at least 100 ppm of the metallic comonomer.

9. The copolymer of claim 1, wherein the metallic comonomer comprises at least 100 ppm of zinc dimethacrylate.

10. The copolymer of claim 1, further comprising 100 to 500 ppm of n-dodecyl mercaptan (NDM).

11. The copolymer of claim 1, comprising less than 4% by weight mineral oil.

12. The copolymer of claim 1, further comprising 100 to 4000 ppm of zinc stearate.

13. The copolymer of claim 1, wherein the weight average molecular weight Mw is greater than 150 kg/mol.

14. The copolymer of claim 1, wherein the weight average molecular weight is from 150 kg/mol to 300 kg/mol.

15. The copolymer of claim 1, wherein the flexural strength is from 6,000 to 15,000 PSI.

16. An article made from the monovinylidene aromatic copolymer of claim 1.

17. A method of producing a copolymer having reduced cycle time comprising:
providing a first monomer and a second metallic comonomer;
polymerizing the first monomer and a second metallic comonomer to make a monovinylidene aromatic copolymer having a melt flow index of at least 7 g/10 min and a Vicat softening temperature of at least 200° F.

18. The method of claim 17, wherein the first monomer is a styrene monomer.

19. The method of claim 17, wherein the metallic comonomer is selected from the group of: zinc diacrylate, zinc dimethacrylate, zinc di-vinylacetate, zinc di-ethylfumarate: copper diacrylate, copper dimethacrylate, copper di-vinylacetate, copper di-ethylfumarate; aluminum (III) isopropoxide, aluminum triacrylate, aluminum trimethacrylate, aluminum tri-vinylacetate, aluminum tri-ethylfumarate; zirconium tetraacrylate, zirconium tetramethacrylate, zirconium tetra-vinylacetate, zirconium tetra-ethylfumarate, zirconium (IV) butoxide; and mixtures thereof.

20. The method of claim 17, wherein the monovinylidene aromatic copolymer has a weight average molecular weight Mw greater than 150 kg/mol.
